(19) United States
(12) Patent Application Publication
(10) Pub. No.: US 2014/0216178 A1
(43) Pub. Date: Aug. 7, 2014

(54) TEST APPARATUS OF GASES

(71) Applicant: JUSUN INSTRUMENTS CO., LTD., NEW TAIPEI CITY (TW)

(72) Inventor: JONATHAN YANG, NEW TAIPEI CITY (TW)

(73) Assignee: JUSUN INSTRUMENTS CO., LTD., NEW TAIPEI CITY (TW)

(21) Appl. No.: 13/798,828

(22) Filed: Mar. 13, 2013

(30) Foreign Application Priority Data
Feb. 1, 2013 (TW) 102202276

(51) Int. Cl. G01N 35/10

(52) U.S. Cl. CPC G01N 35/10
USPC 73/864.81

(57) ABSTRACT

A test apparatus of gases is provided for transmitting gases in a plurality of gas tubes to a test tube for testing, the test apparatus including a test main body, a cover plate and a connecting component for selection. The test main body includes a container tank; gases inside the container tank are exhausted via an exhaust tube. The cover plate is disposed on the test main body for sealing the container tank. The cover plate includes a central channel and a plurality of surrounding channels that surround the central channel. The central channel connects the test tube and the surrounding channels respectively connect the gas tubes. The connecting component for selection is disposed rotatably in the container tank toward a rotating direction and is attached closely to the cover plate. The connecting component for selection includes a central gas outlet and a gas inlet.

This application claims the benefits of the Taiwan Patent Application Serial NO. 102202276 filed on Feb. 1, 2013, the subject matter of which is incorporated herein by reference.

### BACKGROUND OF THE INVENTION

1. Field of the Invention

The present invention relates to a test apparatus for gas and more particularly, relates to a test apparatus of gases for transmitting gases in a plurality of gas tubes to a test tube for testing.

2. Description

Refer to FIG. 1, a cross-sectional view of a conventional test apparatus of gases. A conventional test apparatus of gases PA100 includes a test main body PA1, a cover plate PA2 and a connecting component PA3 connecting one of a plurality of gas tubes PA200 with a test tube PA300. The cover plate PA2 including a plurality of inlets (not shown) disposing the gas tubes PA200. The connecting component PA3 is disposed rotatably in the test main body PA1 and includes a connecting tube PA31 having a gas inlet PA311 and a gas outlet PA312. The connecting component PA3 connects one of the gas tubes PA200 via the gas inlet PA311 so that gases inside the gas tube PA200 is delivered to the test tube PA300. The connecting component PA3 is rotated for selecting one of the gas tubes PA200.

Accordingly, a user selects one of the gas tubes PA200 by rotating the connecting component PA3; however, since the connecting component PA3 can only connect one of the gas tubes PA200 with the test tube PA300 at one time, gases inside other gas tubes PA200 will remain. If the user wishes to test gases inside other gas tubes PA200 by rotating the connecting component PA3 to connect with one of other gas tubes PA200, gases that remains will be tested, which will affect the gas property of the remained gases. For example, when testing pH values of corrosive gases, it is very likely that the pH values will change because the user tested corrosive gases remaining inside the gas tubes PA200, and that the gas tubes may be corroded.

### SUMMARY OF THE INVENTION

In prior art, since a connecting component can only connect one of gas tubes with a test tube at one time, gases inside other gas tubes will remain. Therefore, when a user wishes to test gases inside other gas tubes via the connecting component to connect with one of other gas tubes, gases that remains will be tested, which will affect the gas property of the remained gases—the remaining gases may even have chemical reactions with the connecting component or the gas tubes.

Therefore, a test apparatus of gases is provided. According to embodiments of the present invention, gases inside gas tubes which are not connected with the connecting tube can flow continuously so as to avoid problems generated due to remaining gases

A test apparatus of gases is provided for transmitting gases in a plurality of gas tubes to a test tube for testing according to an embodiment of the present invention, the test apparatus including a test main body, a cover plate and a connecting component for selection.

The test main body includes a container tank; gases inside the container tank are exhausted via an exhaust tube. The cover plate is disposed on the test main body for sealing the container tank. The cover plate includes a central channel and a plurality of surrounding channels that surround the central channel. The central channel connects the test tube and the surrounding channels respectively connect the gas tubes. The connecting component for selection is disposed rotatably in the container tank toward a rotating direction and is attached closely to the cover plate. The connecting component for selection includes a central gas outlet and a gas inlet, the central gas outlet connecting the test tube and the gas inlet connecting the central gas outlet, wherein when the connecting component for selection rotates toward the rotating direction so that the gas inlet connects correspondingly with one of the surrounding channels, gas inside corresponding gas tube is delivered to the test tube via the connecting component for selection.

The connecting component for selection further includes a vent disposed symmetrically on two sides of the central gas outlet with the gas inlet.

The connecting component for selection further includes a power output device having a transmission member. The test main body is disposed on the power output device and the connecting component for selection is fastened to the transmission member by which the connecting component for selection is driven to rotate toward the rotating direction. The transmission member includes a connecting disc and a transmission shaft. The connecting disc is fastened to the connecting component for selection and the transmission shaft is fastened to the connecting disc. The test apparatus of gases further includes a retaining spring disposed through the transmission shaft and propped to the connecting disc and the bottom side of the container tank.

In conclusion, the test apparatus of gases according to embodiments of the present invention connects the one of the gas tubes and the test tube with the connecting component and other gas tubes which are not connected with the connecting component connect to the container tank and gases inside unconnected gas tubes are exhausted via the exhaust tube so gases in the exhaust tube will not remain.

### BRIEF DESCRIPTION OF THE DRAWINGS

Other features and advantages of this invention will become more apparent in the following detailed description of the preferred embodiments of this invention, with reference to the accompanying drawings.

FIG. 1 is a cross-sectional view of a conventional test apparatus of gases.

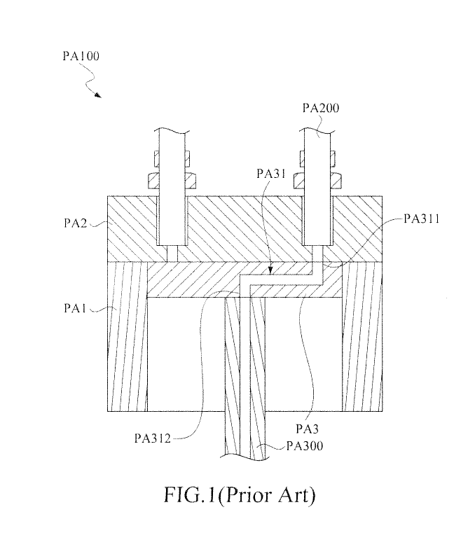

FIG. 2 is a schematic view of a test apparatus of gases according to an embodiment of the present invention.

FIG. 3 is a cross-sectional view of a test apparatus of gases according to an embodiment of the present invention.

FIG. 4 is a view from top of a test apparatus of gases according to an embodiment of the present invention.

FIG. 5 is a view from top of a connecting component inside a container tank according to an embodiment of the present invention.

### DETAILED DESCRIPTION OF THE PREFERRED EMBODIMENT

The present invention relates to a test apparatus of gases. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

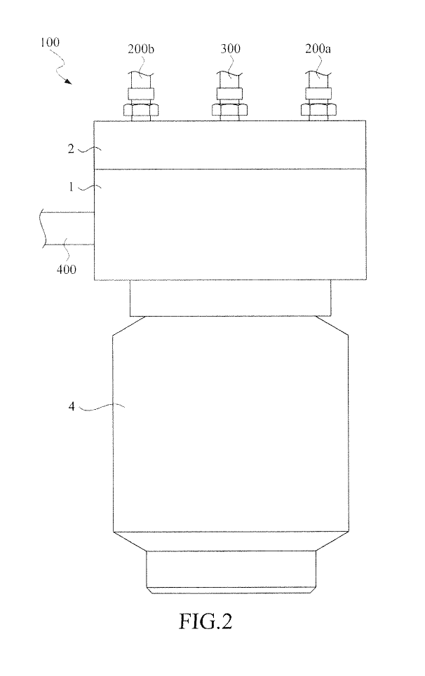

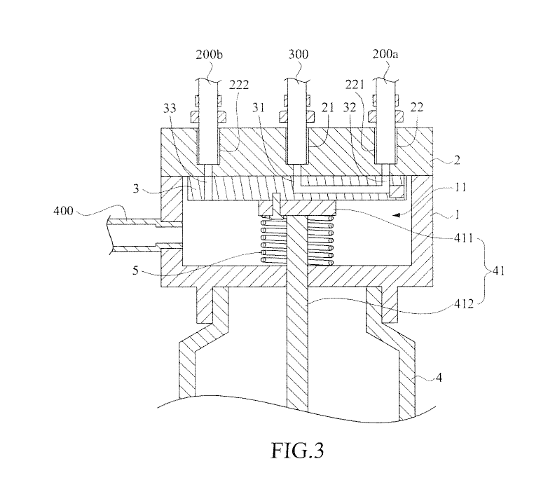

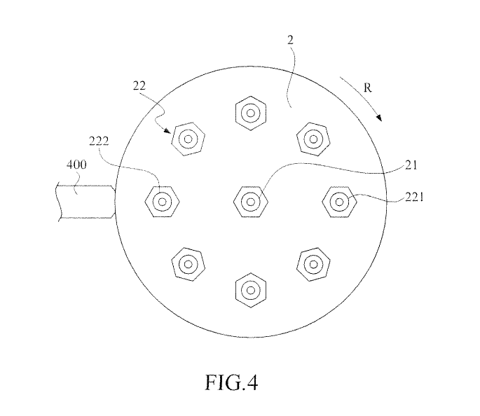

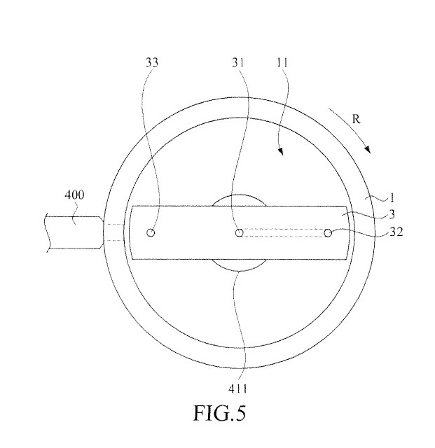

Refer to FIG. 2 to FIG. 5; FIG. 2 is a schematic view of a test apparatus of gases according to an embodiment of the present invention; FIG. 3 is a cross-sectional view of a test apparatus of gases according to an embodiment of the present invention; FIG. 4 is a view from top of a test apparatus of gases according to an embodiment of the present invention; FIG. 5 is a view from top of a connecting component inside a container tank according to an embodiment of the present invention.

According to an embodiment of the present invention, a test apparatus of gases 100 is provided for transmitting gases in a plurality of gas tubes 200a and 200b (only two are identified in the figure) to a test tube 300 for testing, the test apparatus of gases 100 includes a test main body 1, a cover plate 2, a connecting component for selection 3, a power output device 4 and a retaining spring 5.

The test main body 1 includes a container tank 11; gases inside the container tank 11 are exhausted via an exhaust tube 400.

The cover plate 2 is disposed on the test main body 1 for sealing the container tank 11. The cover plate 2 includes a central channel 21 and eight surrounding channels 22 that surround the central channel 21 (two of the eight surrounding channels 22 are identified as 221 and 222). The central channel 21 connects the test tube 300 and the surrounding channels 221 and 222 respectively connect the gas tubes 200a and 200b.

The connecting component for selection 3 is disposed rotatably in the container tank 11 toward a rotating direction R and is attached closely to the bottom side of the cover plate 2. The connecting component for selection 3 includes a central gas outlet 31, a gas inlet 32 and a vent 33. The central gas outlet 31 connects the central channel 21 and the gas inlet 32 connects the central gas outlet 31. The vent 33 is disposed symmetrically on two sides of the central gas outlet 31 with the gas inlet 32 and the vent 33 is corresponding to the surrounding channels 22, wherein the eight surrounding channels 22 evenly surround the periphery of the central channel 21 and the vent 33 is disposed symmetrically with the gas inlet 32; therefore, when the gas inlet 32 connects the surrounding channel 221 to the central channel 21, the vent 33 connects the surrounding channel 222 to the container tank 11.

Since the connecting component for selection 3 includes the gas inlet 32 and the vent 33 symmetrically, the center of gravity of the connecting component for selection 3 is more balanced and thus is attached to the cover plate 2 firmly.

The power output device 4 includes a transmission member 41 and the test main body 1 is disposed on the power output device 4. The transmission member 41 includes a connecting disc 411 and a transmission shaft 412. The connecting disc 411 is fastened to the connecting component for selection 4; the transmission shaft 412 is disposed through the bottom of the test main body 1 and connects the connecting disc 411. The power output device 4 includes a stepping motor (not shown) as its power source and drives the connecting component for selection 3 to rotate via the transmission shaft 412 and the connecting disc so that the user can select one of the eight surrounding channels 22 to connect to the central channel 21 via the connecting component for selection 3.

The retaining spring 5 is disposed through the transmission shaft 412 and propped to the connecting disc 411 and the bottom side of the container tank 11 so the connecting disc 411 allows the connecting component for selection 3 to prop upward against the cover plate 4.

When the user controls the connecting component for selection 3 to rotate toward the rotating direction R with the power output device 4 so the gas inlet 32 correspondingly connects the surrounding channel 221 which is one of the eight surrounding channels 22, gases inside the gas tube 200a disposed in the surrounding channel 221 is transmitted to the test tube 300 via the connecting component for selection 3 so the user can test the gas inside the gas tube 200a.

Compared with prior art, in which gases inside unconnected gas tubes will remain and the property of gases is further affected, resulting in tests full of errors, the test apparatus of gases of an embodiment of the present invention includes the vent 33 connecting the surrounding channel 222 which is relatively disposed to the surrounding channel 221 to the container tank 11; besides, gases in other surrounding channels 22 also directly connect the container tank 11 so the gases in the container tank 11 are continuously exhausted via the exhaust tube 400. The surrounding channels 22 are kept clear so as to avoid gas reactions. According to an embodiment of the present invention, gases in the container tank 11 are exhausted with a negative pressure generated by the exhaust tube 400 connecting a pump. According to another embodiment of the present invention, gases in the container tank 11 are exhausted with a pressure generated by the gas tubes 200a and 200b connecting a pump, while the test tube 300 can also extract gases to the test apparatus of gases via a negative pressure or a pressure generated by gas tubes 200a and 200b.

Besides, the test main body 1, the cover plate 2 and the connecting component for selection 3 include materials of Polytetrafluoroethene (PTFE) and thus can effectively avoid reactions generated among gases in the gas tubes 200a and 200b and the test main body 1, the cover plate 2 and the connecting component for selection 3. Also, friction between the bottom of the cover plate 2 and the connecting component for selection 3 is decreased so these two can be attached with each other.

While the present invention has been particularly shown and described with reference to a preferred embodiment, it will be understood by those skilled in the art that various changes in form and detail may be without departing from the spirit and scope of the present invention.

What is claimed is:

1. A test apparatus of gases for transmitting gases in a plurality of gas tubes to a test tube for testing, the test apparatus of gases comprising:
a test main body including a container tank, gases inside the container tank being exhausted via an exhaust tube;
a cover plate disposed on the test main body, the cover plate sealing the container tank and including a central channel and a plurality of surrounding channels that surround the central channel, the central channel connecting the test tube and the surrounding channels respectively connecting the gas tubes; and
a connecting component for selection disposed rotatably in the container tank toward a rotating direction and attached closely to the cover plate, the connecting component for selection including a central gas outlet and a gas inlet, the central gas outlet connecting the central channel and the gas inlet connecting the central gas outlet;
wherein when the connecting component for selection rotates toward the rotating direction so that the gas inlet connects correspondingly with one of the surrounding channels, gas inside corresponding gas tube is delivered to the test tube via the connecting component for selection.

2. The test apparatus of gases according to claim 1, where in the connecting component for selection further includes a vent disposed symmetrically on two sides of the central gas outlet with the gas inlet.

3. The test apparatus of gases according to claim 1, further comprising a power output device having a transmission member, the test main body being disposed on the power output device. the connecting component for selection fastened to the transmission member by which the connecting component for selection is driven to rotate toward the rotating direction.

4. The test apparatus of gases according to claim 3, wherein the transmission member includes a connecting disc and a transmission shaft, the connecting disc being fastened to the connecting component for selection and the transmission shaft being fastened to the connecting disc.

5. The test apparatus of gases according to claim 4, further comprising a retaining spring disposed through the transmission shaft and propped to the connecting disc and the bottom side of the container tank.
